(19) United States
(12) Patent Application Publication
(10) Pub. No.: US 2017/0344929 A1
(43) Pub. Date: Nov. 30, 2017

(54) INFORMATION PROCESSING APPARATUS, METHOD FOR INSTRUCTING QUICK FIX, AND PROGRAM PRODUCT

(71) Applicants: Yutaka MATSUMURA, Kanagawa (JP); Takenori OKU, Saitama (JP); Fumihiro NAGANO, Kanagawa (JP); Hiroshi NISHIDA, Kanagawa (JP); Satoshi HATANAKA, Kanagawa (JP); Satoshi MIZUNO, Tokyo (JP); Suntao YAN, Kanagawa (JP); Takeharu KOGA, Tokyo (JP); Yoshimi MATSUSHIMA, Tokyo (JP)

(72) Inventors: Yutaka MATSUMURA, Kanagawa (JP); Takenori OKU, Saitama (JP); Fumihiro NAGANO, Kanagawa (JP); Hiroshi NISHIDA, Kanagawa (JP); Satoshi HATANAKA, Kanagawa (JP); Satoshi MIZUNO, Tokyo (JP); Suntao YAN, Kanagawa (JP); Takeharu KOGA, Tokyo (JP); Yoshimi MATSUSHIMA, Tokyo (JP)

(21) Appl. No.: 15/597,547

(22) Filed: May 17, 2017

(30) Foreign Application Priority Data
May 24, 2016 (JP) 2016-103687

(51) Int. Cl. G06Q 10/06; G06Q 10/00

(52) U.S. Cl. CPC G06Q 10/063114; G06Q 10/20

(57) ABSTRACT

An information processing apparatus includes circuitry. The circuitry acquires, from equipment in which a fault has occurred, status information indicating a status of the equipment. The circuitry checks whether a maintenance person who is in an available state is present from among a plurality of maintenance persons. The circuitry identifies a type of the fault that has occurred in the equipment, based on the acquired status information. In a case in which no maintenance person who is in the available state is present from among the plurality of maintenance persons, the circuitry instructs the equipment to output a quick fix technique, which enables working around the fault of the identified type to enable continued use of the equipment.

### CROSS-REFERENCE TO RELATED APPLICATION

This patent application is based on and claims priority pursuant to 35 U.S.C. §119(a) to Japanese Patent Application No. 2016-103687, filed on May 24, 2016, the entire disclosure of which is hereby incorporated by reference herein.

### BACKGROUND

Technical Field

The present disclosure relates to an information processing apparatus, a method for instructing a quick fix, and a program product.

Description of the Related Art

Most equipment manufacturers or equipment vendors that sell or lease equipment to customers usually provide the customers with after-sales service for the equipment sold. Examples of after-service include dispatching a maintenance person such as a service engineer to a customer to perform maintenance in a case in which a fault or breakdown occurs in the equipment sold or leased to the customer.

### SUMMARY

An information processing apparatus includes circuitry. The circuitry acquires, from equipment in which a fault has occurred, status information indicating a status of the equipment. The circuitry checks whether a maintenance person who is in an available state is present from among a plurality of maintenance persons. The circuitry identifies a type of the fault that has occurred in the equipment, based on the acquired status information. In a case in which no maintenance person who is in the available state is present from among the plurality of maintenance persons, the circuitry instructs the equipment to output a quick fix technique, which enables working around the fault of the identified type to enable continued use of the equipment.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 is a block diagram illustrating an example configuration of a system according to an embodiment of the present disclosure;

FIG. 2 is a block diagram illustrating an example hardware configuration of a piece of equipment according to an embodiment of the present disclosure;

FIG. 3 is a block diagram illustrating an example hardware configuration of an information processing apparatus according to an embodiment of the present disclosure;

FIG. 4 is a block diagram illustrating an example hardware configuration of a portable terminal according to an embodiment of the present disclosure;

FIG. 5 is a block diagram illustrating an example hardware configuration of a terminal apparatus according to an embodiment of the present disclosure;

FIG. 6 is a block diagram illustrating an example functional configuration of the system according to an embodiment of the present disclosure;

FIG. 7 is a sequence diagram illustrating steps in an operation from a step of detecting a fault to a step of determining presence of a maintenance person who deals with the maintenance of the fault, performed by the system according to an embodiment of the present disclosure;

FIG. 8 is a view illustrating an example of an input screen according to an embodiment of the present disclosure;

FIG. 9 is an illustration for describing an example of a plurality of pieces of availability status information stored in an availability status information storage unit according to an embodiment of the present disclosure;

FIG. 10 is a sequence diagram illustrating steps in an operation of dispatching a maintenance person who is in an available state to a customer, performed by the system according to an embodiment of the present disclosure;

FIG. 11 is an illustration for describing an example of customer information stored in a customer information storage unit according to an embodiment of the present disclosure;

FIG. 12 is an illustration for describing an example of action status information stored in an action status information storage unit according to an embodiment of the present disclosure;

FIG. 13 is a sequence diagram illustrating steps in an operation of determining a technique for quick fix, performed by the system in a case in which no maintenance person who is in an available state is present, according to an embodiment of the present disclosure;

FIG. 14 is an illustration for describing an example of quick fix determination information stored in a quick fix determination information storage unit according to an embodiment of the present disclosure;

FIG. 15 is a sequence diagram illustrating steps in an operation of outputting a quick fix technique, performed by the system in a case in which a fault is a fault for which an output of the quick fix technique is possible, according to an embodiment of the present disclosure;

FIG. 16 is illustration for describing an example of action status information stored in an action status information storage unit according to an embodiment of the present disclosure;

FIG. 17 is a view illustrating an example of a confirmation screen according to an embodiment of the present disclosure;

FIG. 18 is a view illustrating an example of a screen indicating a quick fix technique according to an embodiment of the present disclosure;

FIG. 19 is a sequence diagram illustrating steps in an operation of reporting the quick fix technique, performed by the system in a case in which a fault is a fault for which the output of the quick fix technique is impossible, according to an embodiment of the present disclosure;

FIG. 20 is an illustration for describing an example of contact information displayed by a display controller according to an embodiment of the present disclosure;

FIG. 21 is a sequence diagram illustrating steps in an operation of dispatching a maintenance person to a customer, performed by the system, after the output of the quick fix technique, according to an embodiment of the present disclosure, and

FIG. 22 is a sequence diagram illustrating steps in an operation from a step of detecting a fault to a step of determining presence of a maintenance person who deals with the maintenance of the fault, performed by the system, according to a modified example of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the multiple forms as well, unless the context clearly indicates otherwise.

Hereinafter, a description is given in detail of several embodiments of an information processing apparatus, a method for instructing a quick fix, and a program product with reference to appended drawings.

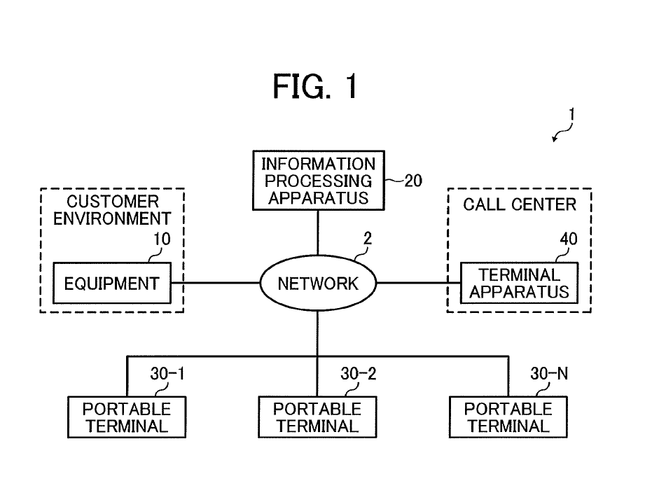

FIG. 1 is a block diagram illustrating a configuration of a system 1 according to an embodiment. As illustrated in FIG. 1, the system 1 includes equipment 10, an information processing apparatus 20, portable terminals 30-1 to 30-N (where N is a natural number), and a terminal apparatus 40.

The equipment 10, the information processing apparatus 20, the portable terminals 30-1 to 30-N, and the terminal apparatus 40 are connected to each other through a network 2. The network 2 is implemented, for example, by the Internet or a local area network (LAN). Hereinafter, the portable terminals 30-1 to 30-N may be collectively referred to as a “portable terminal 30” to simplify description when there is no need to distinguish between them.

The equipment 10 is equipment that is sold or leased to a customer by an equipment manufacturer or an equipment vendor as an operator of the information processing apparatus 20. The equipment 10 is located in a customer environment of the customer. Examples of the equipment 10 include an image forming apparatus such as a printer, a copier, a multifunction peripheral, a scanner and a facsimile, various types of an electronic apparatus such as a projector, a camera, an air conditioner, a refrigerator, a fluorescent lamp, a vending machine and a hand-held terminal, and an information processing apparatus such as a personal computer (PC). The multifunction peripheral has at least two of a copier function, a print function, a scanner function, a facsimile function. Although in the present embodiment, a description is given of a case in which the equipment 10 is an image forming apparatus, the equipment 10 is not limited thereto. Note that, although the system 1 of FIG. 1 includes one equipment 10, the equipment 10 could be more than one device.

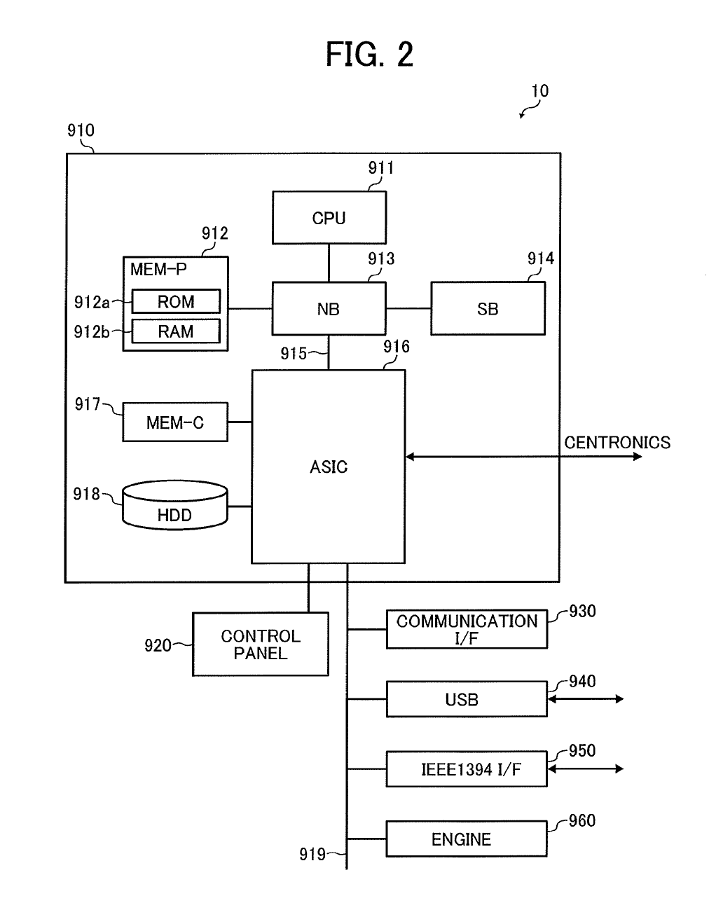

FIG. 2 is a block diagram illustrating an example hardware configuration of the equipment 10 according to the present embodiment. As illustrated in FIG. 2, the equipment 10 includes a controller 910 and an engine 960, which are connected with each other via a peripheral component interface (PCI) bus 919. The controller 910 controls entire operation of the equipment 10. In an example operation, the controller 910 controls drawing, communication, or user inputs to a control panel 920. The engine 960 is an engine that can be connected to the PCI bus 919. Examples of the engine 960 include a scanner engine such as a scanner. The engine 960 includes, in addition to the engine part, an image processing part such as error diffusion or gamma conversion.

The controller 910 includes a central processing unit (CPU) 911, a north bridge (NB) 913, a system memory (MEM-P) 912, a south bridge (SB) 914, a local memory (MEM-C) 917, an Application Specific Integrated Circuit (ASIC) 916, and a hard disc drive (HDD) 918. The NB 913 and the ASIC 916 are connected through an Accelerated Graphics Port (AGP) bus 915. Further, the MEM-P 912 includes a read only memory (ROM) 912a and a random access memory (RAM) 912b.

The CPU 911 controls entire operation of the equipment 10. The CPU 911 is connected to another device via a chip set constituted by the NB 913, the MEM-P 912, and the SB 914.

The NB 913 is a bridge for connecting the CPU 911, the MEM-P 912, the SB 914, and the AGP bus 915 to one other. The NB 913 includes a memory controller to control reading and writing data to and from the MEM-P 912, a PCI master, and an AGP target.

The MEM-P 912 is a system memory used as, for example, a memory to store programs or data, a memory to deploy programs or data, and a memory to store drawing data for printing. The MEM-P 912 includes the ROM 912a and the RAM 912b. The ROM 912a is a read only memory used as a memory to store programs or data. The RAM 912b is a read-write memory used as, for example, a memory to deploy programs or data and a memory to store drawing data for printing.

The SB 914 is a bridge that connects the NB 913 with a PCI device or a peripheral device. The SB 914 is connected to the NB 913 via a PCI bus.

The ASIC 916 is an integrated circuit (IC) adapted for image processing that includes image processing hardware elements. The ASIC 916 functions as a bridge that connects the AGP bus 915, the PCI bus 919, the HDD 918, and MEM-C 917. The ASIC 916 includes a PCI target, an AGP master, an arbiter (ARB) as a core of the ASIC 916, a memory controller for controlling the MEM-C 917, a plurality of direct memory access controllers (DMACs) for performing rotation and the like of image data by a hardware logic, and a PCI unit for exchanging data with the engine 960 via the PCI bus 919. The ASIC 916 is connected to a communication interface (I/F) 930, a universal serial bus (USB) 940, an institute of electrical and electronics engineers (IEEE) 1394 interface 950 via the PCI bus 919. The control panel 920 is directly connected to the ASIC 916.

The MEM-C 917 is a local memory used as a buffer for image data to be copied or coded. The HDD 918 is a storage for storing image data, programs, font data, and forms.

The AGP bus 915 is a bus interface for a graphics accelerator card that is proposed for enhancing the speed of graphic processing. The AGP bus 915 directly accesses the MEM-P 912 with high throughput to enhance the speed of the graphics accelerator card.

The information processing apparatus 20 is a server apparatus that is managed by the operator such as the equipment manufacturer and the equipment vendor. The information processing apparatus 20 performs remote managing of the equipment 10 that is sold or leased to a customer. The information processing apparatus 20 is implemented by one or more computers, for example. In the present embodiment, a description is given of an example case in which the information processing apparatus 20 is implement by one computer. However, the information processing apparatus 20 may be implemented as an information processing system constituted by two or more computers.

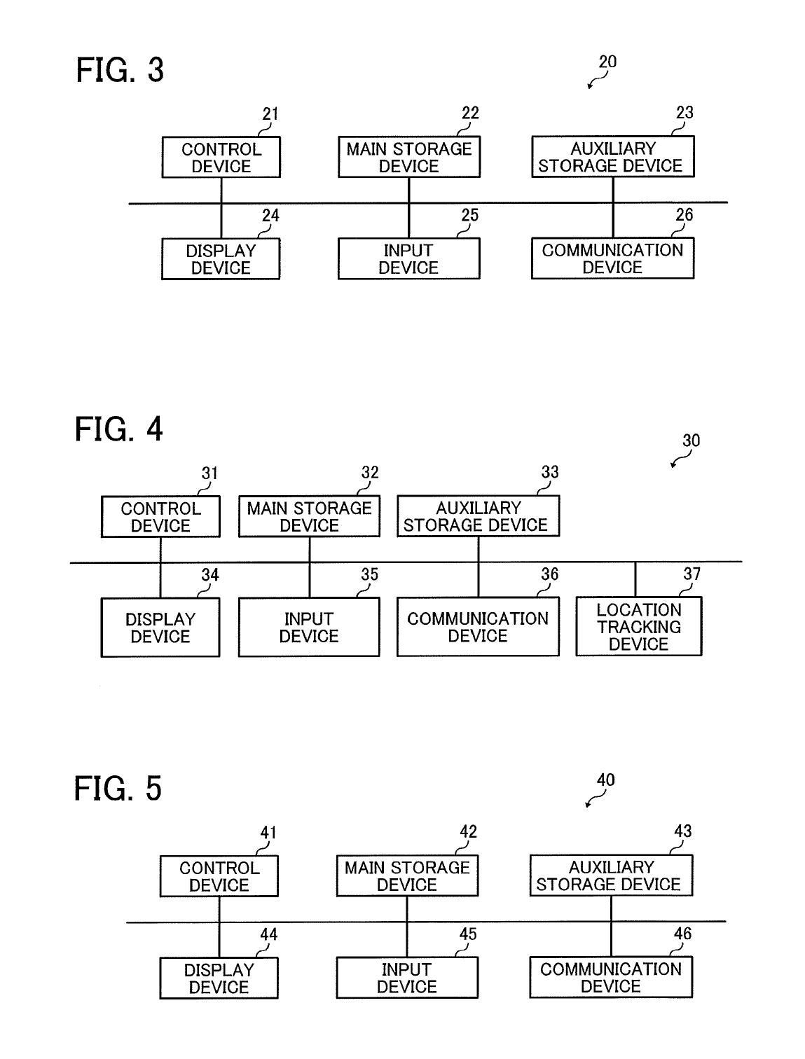

FIG. 3 is a block diagram illustrating an example hardware configuration of the information processing apparatus 20 according to the present embodiment. The information processing apparatus 20 includes a control device 21, a main storage device 22, an auxiliary storage device 23, a display device 24 such as a display, an input device 25, and a communication device 26 such as a communication interface. Examples of the control device 21 include a CPU and a graphics processing unit (GPU). Examples of the main storage device 22 include a ROM and a RAM. Examples of the auxiliary storage device 23 include an HDD and a solid state drive (SSD). Examples of the input device 25 include a keyboard and a mouse. A general-purpose computer may be used to implement this hardware configuration.

The portable terminal 30 is a portable terminal that the maintenance person (service engineer) of the operator such as the equipment manufacturer or the equipment vendor carries with him/her. Examples of the portable terminal 30 include a smart terminal. In the present embodiment, it is assumed that one or more portable terminals 30 are provided such that each maintenance person can carry one portable terminal 30 with him/her.

The portable terminal 30 notifies the information processing apparatus 20 of information indicating whether the maintenance person is in an available status or unavailable status. Further, the portable terminal 30 accepts, from the information processing apparatus 20, an instruction to dispatch the maintenance person to a customer. It should be noted that the unavailable status indicates a status in which the maintenance person is currently serving a customer for maintenance and is not available for another maintenance task. The available status indicates a status in which the maintenance person is not currently serving a customer for maintenance and is available for a maintenance task. However, these are just examples of the unavailable status and the available status, and they are not limited thereto.

FIG. 4 is a block diagram illustrating an example hardware configuration of the portable terminal 30 according to the present embodiment. The portable terminal 30 includes a control device 31, a main storage device 32, an auxiliary storage device 33, a display device 34 such as a display, an input device 35, a communication device 36 such as a communication interface, and a location tracking device 37. Examples of the control device 31 include a CPU and a GPU. Examples of the main storage device 32 include a ROM and a RAM. Examples of the auxiliary storage device 33 include an HDD and an SSD. Examples of the input device 35 include a touch panel. Examples of the location tracking device 37 include a global positioning system (GPS) receiver. A general-purpose computer may be used to implement this hardware configuration.

The terminal apparatus 40 is a terminal that is located, for example, at a call center of the operator such as the equipment manufacturer and the equipment vendor. Examples of the terminal apparatus 40 include a PC. The terminal apparatus 40 is an example of an information processing apparatus used for operation of transmitting and receiving instructions or requests by telephone. Note that, although only one terminal apparatus 40 is illustrated in FIG. 1, in fact, the system 1 includes one or more terminal apparatuses 40 such that each operator at the call center is provided with one terminal apparatus 40. The operator deals with operations of transmitting and receiving instructions or requests by telephone by using the terminal apparatus 40.

FIG. 5 is a block diagram illustrating an example hardware configuration of the terminal apparatus 40 according to the present embodiment. The terminal apparatus 40 includes a control device 41, a main storage device 42, an auxiliary storage device 43, a display device 44 such as a display, an input device 45, and a communication device 46 such as a communication interface. Examples of the control device 41 include a CPU and a GPU. Examples of the main storage device 42 include a ROM and a RAM. Examples of the auxiliary storage device 43 include an HDD and an SSD. Examples of the input device 45 include a keyboard and a mouse. A general-purpose computer may be used to implement this hardware configuration.

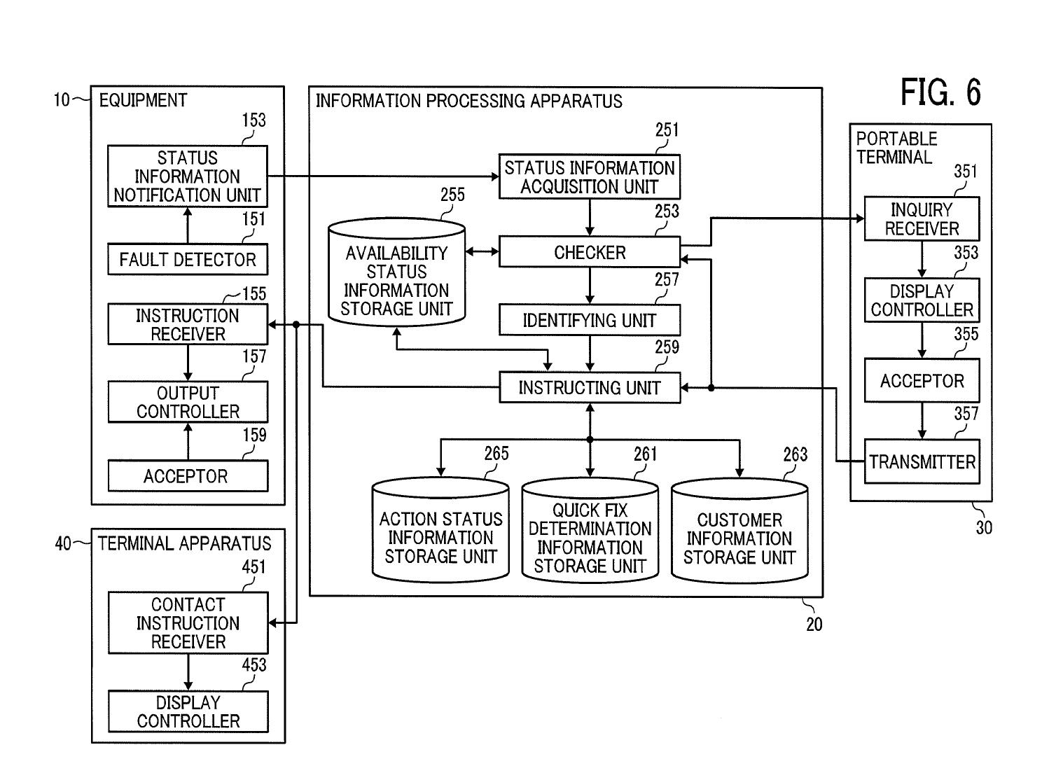

FIG. 6 is a block diagram illustrating an example functional configuration of the system 1 according to the present embodiment. As illustrated in FIG. 6, the equipment 10 includes a fault detector 151, a status information notification unit 153, an instruction receiver 155, an output controller 157, and an acceptor 159.

Each of the fault detector 151, the output controller 157, and the acceptor 159 is implement by, for example, the CPU 911 and the MEM-P 912. Each of the status information notification unit 153 and the instruction receiver 155 is implement by, for example, the CPU 911, the MEM-P 912, and the communication interface 930.

Further, as illustrated in FIG. 6, the information processing apparatus 20 includes a status information acquisition unit 251, a checker 253, an availability status information storage unit 255, an identifying unit 257, an instructing unit 259, a quick fix determination information storage unit 261, a customer information storage unit 263, and an action status information storage unit 265.

Each of the status information acquisition unit 251, the checker 253 and the instructing unit 259 is implemented, for example, by the control device 21, a main storage device 22, and the communication device 26. Each of the availability status information storage unit 255, the quick fix determination information storage unit 261, the customer information storage unit 263 and the action status information storage unit 265 is implemented, for example, by the auxiliary storage device 23. The identifying unit 257 is implemented, for example, by the control device 21 and the main storage device 22.

Furthermore, as illustrated in FIG. 6, the portable terminal 30 includes an inquiry receiver 351, a display controller 353, an acceptor 355, and a transmitter 357. Each of the inquiry receiver 351 and the transmitter 357 is implemented, for example, by the control device 31, the main storage device 32, and the communication device 36. Each of the display controller 353 and the acceptor 355 is implemented, for example, by the control device 31 and the main storage device 32.

Still further, as illustrated in FIG. 6, the terminal apparatus 40 includes a contact instruction receiver 451 and the display controller 453. The contact instruction receiver 451 is implemented, for example, by the control device 41, the main storage device 42, and the communication device 46. The display controller 453 is implemented, for example, by the control device 41 and the main storage device 42.

Hereinafter, a description is given of steps in an operation performed by the system 1 according to the present embodiment.

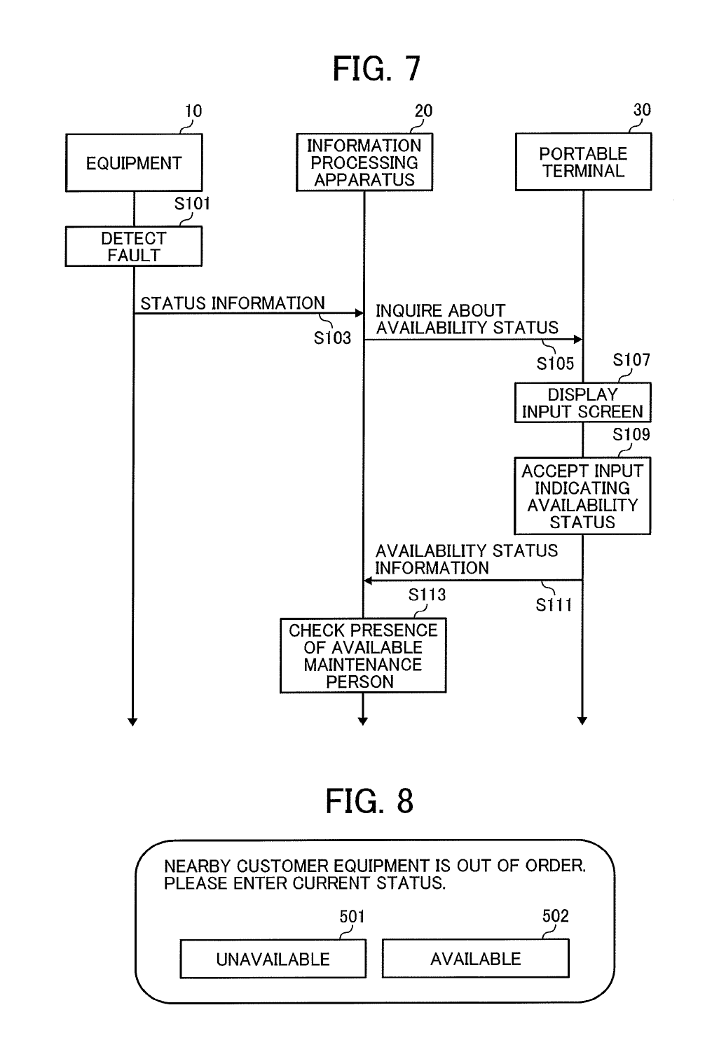

FIG. 7 is a sequence diagram illustrating steps in an operation from a step of detecting a fault to a step of determining presence of a maintenance person who deals with the maintenance of the fault, the operation being performed by the system 1 according to the present embodiment.

First, the fault detector 151 of the equipment 10 detects a fault that has occurred in the equipment 10 (S101).

In this disclosure, the fault indicates a state in which the equipment 10 cannot be activated or a state in which the equipment 10 cannot perform operation instructed by a user (customer) of the equipment 10. Examples of the fault include a breakdown or an error occurring in the equipment 10. It should be noted that the fault detector 151 only has to detect an occurrence of a fault, or determine that a fault has occurred, when the equipment 10 cannot be activated or the equipment 10 cannot perform an operation instructed by a user (customer) of the equipment 10. In other words, the fault detector 151 does not have to identify the type of fault occurring in the equipment 10.

Next, in response to the detection of fault by the fault detector 151, the status information notification unit 153 of the equipment 10 notifies the information processing apparatus 20 of status information indicating the status of the equipment 10 (S103). Thus, the status information acquisition unit 251 of the information processing apparatus 20 acquires, from the equipment 10 in which the fault has occurred, the status information of the equipment 10.

In this disclosure, the status information of the equipment 10 may any type of information indicating the status of the equipment 10. Examples of the status information includes, not limited thereto, the number of counters, an operation period of time, information indicating an error part that does not operate normally (e.g. information of a motor that does not rotate normally). Further, in the present embodiment, the status information of the equipment 10 includes, not limited thereto, a fault occurrence information indicating that a fault has occurred in the equipment 10, equipment identification information such as a serial number identifying the equipment 10, and customer identification information such as a customer name identifying a customer who uses the equipment 10.

Next, in response to the acquisition of the status information by the status information acquisition unit 251, the checker 253 of the information processing apparatus 20 queries each of the portable terminals 30-1 to 30-N for an availability status (S105). In other words, the checker 253 makes a request for inquiring the availability status. The inquiry receiver 351 of each portable terminal 30 receives, from the information processing apparatus 20, the inquiry about the availability status (the request for inquiring the availability status).

Next, in response to receiving the inquiry about the availability status by the inquiry receiver 351, the display controller 353 of each portable terminal 30 controls the display device 34 to display an input screen that accepts an input indicating whether a maintenance person who carries the portable terminal 30 is in the available state or the unavailable state (S107).

Next, the acceptor 355 of each portable terminal 30 accepts an input of the availability status entered by the maintenance person who carries the portable terminal 30 through the input device 35 (S109).

FIG. 8 illustrates an example of the input screen according to the present embodiment. The input screen illustrated in FIG. 8 includes an unavailable status key 501 and an available status key 502. In response to selection (touch) of the unavailable status key 501 by the maintenance person who carries the portable terminal 30, the acceptor 355 accepts, from the input device 35, an input indicating that the availability status of the maintenance person is in the unavailable state (e.g., serving a customer for maintenance). On the contrary, in response to selection of the available status key 502, the acceptor 355 accepts, from the input device 35, an input indicating that the availability status of the maintenance person is in the available status.

Next, the transmitter 357 of each portable terminal 30 transmits, to the information processing apparatus 20, availability status information accepted by the acceptor 355 indicating the availability status (e.g., whether the maintenance person is in the available status or unavailable status) (S111). The checker 253 of the information processing apparatus 20 receives the availability status information from each of the portable terminals 30-1 to 30-N.

Although in the present embodiment, a description is given of an example in which the availability status information includes maintenance person identification information such as a maintenance person's name identifying a maintenance person who carries the portable terminal 30 and location information indicating a location of the portable terminal 30, the availability status information is not limited thereto. It should be noted that the maintenance person identification information is stored in advance in the auxiliary storage device 33, for example. In addition, the location information may be determined by the location tracking device 37.

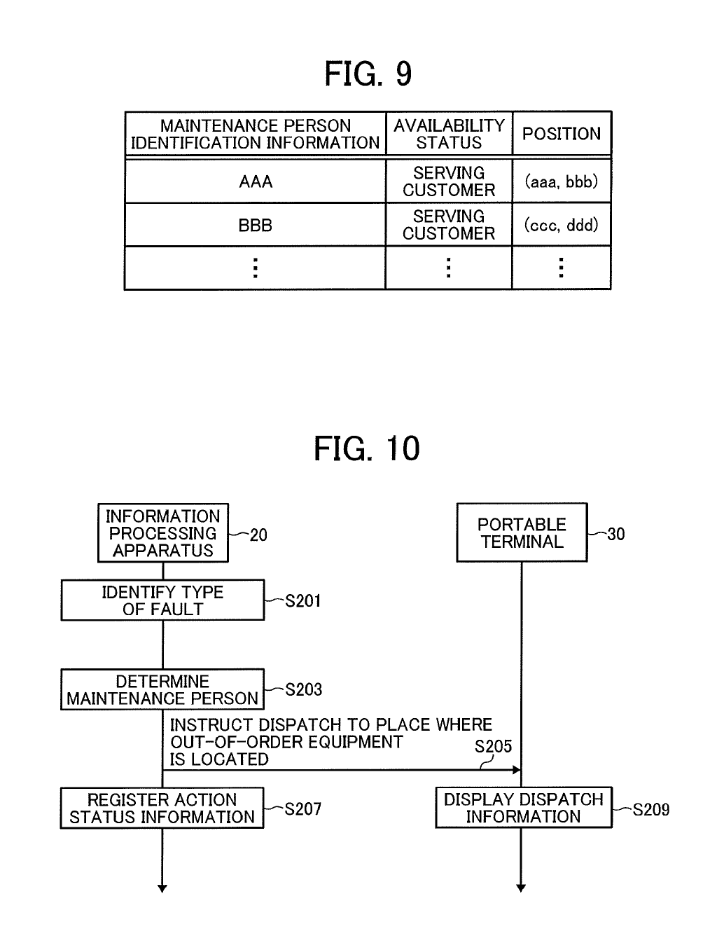

Next, the checker 253 refers to a plurality of pieces (N-numbers) of the availability status information received from the portable terminals 30-1 to 30-N to check whether any maintenance person who is in the available status is present (S113). Specifically, the checker 253 stores the availability status information received from each portable terminal 30 in the availability status information storage unit 255. FIG. 9 is an illustration for describing an example of the plurality of pieces of the availability status information stored in the availability status information storage unit 255 according to the present embodiment. More specifically, the checker 253 determines that there is a maintenance person who is in the available status in a case in which the plurality of pieces of the availability status information stored in the availability status information storage unit 255 contain the availability status information indicating that the availability status is the available status. On the contrary, in a case in which the plurality of pieces of the availability status information stored in the availability status information storage unit 255 do not contain the availability status information indicating that the availability status is the available status, the checker 253 determines that there is no maintenance person who is in the available status.

With the processes of S105 to S113, the checker 253 checks whether there is a maintenance person who is in the available state from among plural maintenance persons.

FIG. 10 is a sequence diagram illustrating steps in an operation of dispatching a maintenance person who is in the available state to a customer, performed by the system 1 according to the present embodiment. This operation is performed in a case in which the checker 253 of the information processing apparatus 20 determines that there is a maintenance person who is in the available state at S113 of the sequence diagram of FIG. 7.

First, the identifying unit 257 of the information processing apparatus 20 identifies a type of the fault that has occurred in the equipment 10 based on the status information acquired by the status information acquisition unit 251 (S201). In other words, the identifying unit 257 identifies which type of fault is occurring in the equipment 10. It should be noted that the identification of the type of the fault based on the status information may be performed by using known techniques. For example, the type of the fault is identified based on the status information by using machine learning. Alternatively, the type of fault may be identified by using information indicating an error part contained in the status information.

Next, the instructing unit 259 of the information processing apparatus 20 determines a maintenance person who is to perform maintenance of the equipment 10 in which a fault has occurred from the maintenance person(s) who is in the available state (S203). For example, in a case in which there is only one maintenance person who is in the available state, the instructing unit 259 determines this maintenance person as a maintenance person who is to perform maintenance of the equipment 10. By contrast, in a case in which there are multiple maintenance persons, each being in the available state, the instructing unit 259 may select a maintenance person who is closest to a location of the equipment 10 in which the fault has occurred, i.e., a customer environment where the equipment 10 is placed, from among the plural maintenance persons in the available status as a maintenance person who is to perform maintenance of the equipment 10.

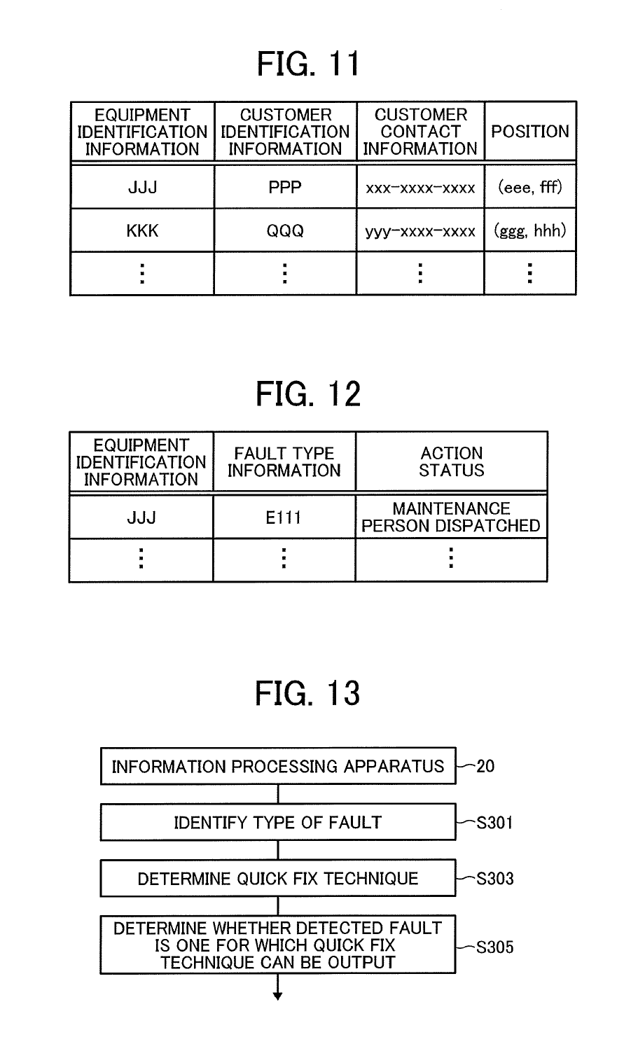

FIG. 11 is an illustration for describing an example of the customer information stored in the customer information storage unit 263 according to the present embodiment. In an example illustrated in FIG. 11, the customer information associates the equipment identification information of a customer's equipment, the customer identification information of a customer, customer contact information indicating a contact destination of a customer, and customer location information indicating a location of a customer environment with one another. Although in the present embodiment, a description is given of an example in which the contact destination of the customer is a phone number, the contact destination may be any other suitable item such as an email address.

It should be noted that the instructing unit 259 may determine the maintenance person who is closest to the customer environment as below. The instructing unit 259 checks the equipment identification information and the customer identification information contained in the status information acquired by the status information acquisition unit 251 against the customer information stored in the customer information storage unit 263 to identify a location of the customer environment of the customer using the equipment 10 in which the fault has occurred. Further, the instructing unit 259 identifies the location of each of the plural maintenance persons in the available state based on the plurality pieces of the availability status information stored in the availability status information storage unit 255. Furthermore, the instructing unit 259 calculates, for each of the plural maintenance persons in the available state, a distance (e.g., a straight line distance) between the location of the maintenance person and the location of the customer environment. Still further, the instructing unit 259 selects the maintenance person for which the calculated distance is shortest as the maintenance person who is closest to the customer environment.

Next, the instructing unit 259 sends, to the portable terminal 30 carried by the determined (selected) maintenance person, an instruction for dispatch of the maintenance person to the location of the equipment 10 in which the fault has occurred, i.e., the customer environment where the equipment 10 is placed (S205). Accordingly, the inquiry receiver 351 of the portable terminal 30 receives the instruction from the instructing unit 259. In the present embodiment, a description is given of an example, not limited thereto, in which the instructing unit 259 transmits, to the portable terminal 30 carried by the determined (selected) maintenance person, dispatch information including a location of the customer environment where the equipment 10 in which the fault has occurred is placed and a type of the fault that has occurred in the equipment 10 identified by the identifying unit 257, and in response to receiving the dispatch information, the inquiry receiver 351 of the portable terminal 30 instructs the dispatch of the maintenance person to the user environment.

Next, the instructing unit 259 generates action status information indicating how the fault of the equipment 10 is being handled, and stores the action status information in the action status information storage unit 265 (S207). FIG. 12 is an illustration for describing an example of the action status information stored in the action status information storage unit 265. In an example illustrated in FIG. 12, the action status information for the fault of the equipment 10 includes the equipment identification information of the equipment 10, fault type information indicating the type of the fault of the equipment 10, and “Maintained Person Dispatched” as an action status taken to deal with the fault of the equipment 10. However, these are just an example of the action status information, and any other suitable information item may be included.

Next, the display controller 353 of the portable terminal 30 controls the display device 34 to display the dispatch information received by the inquiry receiver 351 (S209). Thus, the maintenance person carrying the portable terminal 30 with him/her is informed of a customer environment of the dispatch destination or a maintenance content. Accordingly, the maintenance person is able to go to the customer environment as recognizing the maintenance content.

FIG. 13 is a sequence diagram illustrating steps in an operation of determining a technique for quick fix, performed by the system 1 of the present embodiment. This operation is performed in a case in which the checker 253 of the information processing apparatus 20 determines that there is no maintenance person who is in the available state at S113 in the sequence diagram of FIG. 7.

First, the identifying unit 257 of the information processing apparatus 20 identifies a type of the fault that has occurred in the equipment 10 based on the status information acquired by the status information acquisition unit 251 (S301). It should be noted that an operation of S301 is performed in substantially the similar manner as described above referring to S201 in the sequence diagram of FIG. 10.

Next, the instructing unit 259 of the information processing apparatus 20 determines a quick fix technique that enables continued use of the equipment 10 by working around the fault of the type identified by the identifying unit 257 (S303).

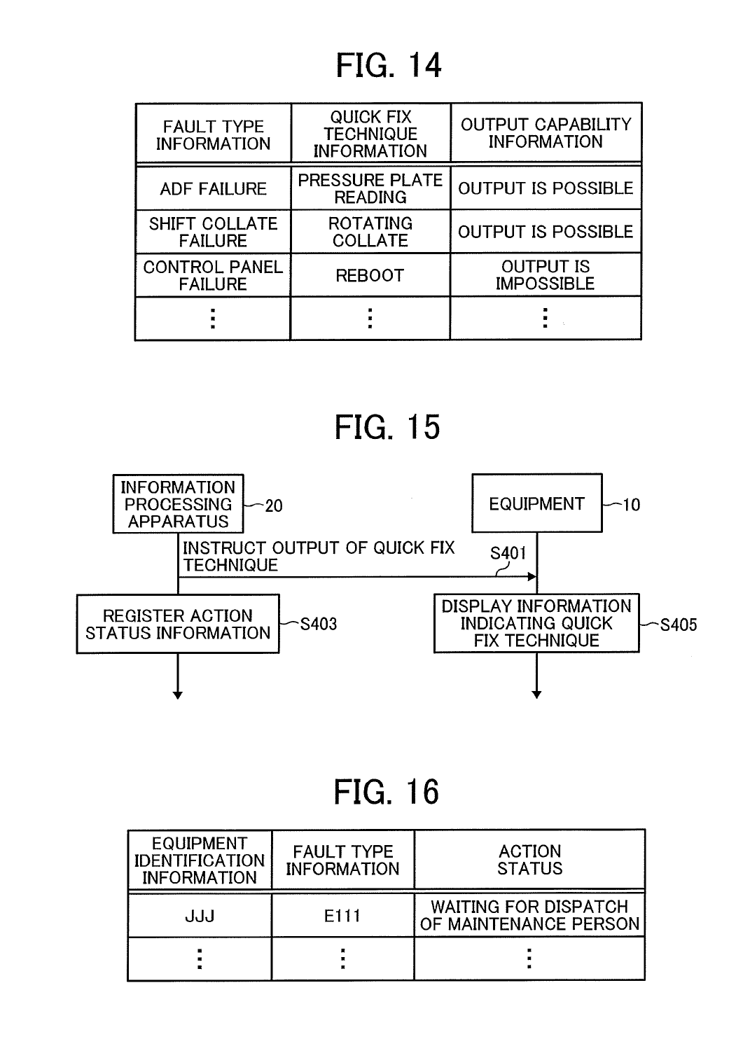

FIG. 14 is an illustration for describing an example of quick fix determination information stored in the quick fix determination information storage unit 261 according to the present embodiment. In an example illustrated in FIG. 14, the quick fix determination information associates the fault type information indicating a type of a fault, quick fix technique information indicating a quick fix technique, output capability information indicating whether the corresponding fault is a fault of a type for which output of the quick fix technique is possible with one another.

It should be noted that in an example illustrated in FIG. 14, an automatic document feeder (ADF) failure as the type of fault is associated with a pressure plate reading as the quick fix technique. In other words, in the quick fix technique for addressing the ADF failure, documents directly placed at a reading position are scanned instead of reading documents transferred by an ADF.

Further, a shift collate failure as the type of fault is associated with a rotating collate as the quick fix technique. In other words, in the quick fix technique for addressing a fault of a shift collate function, printed matter is collated by using a function of a rotating collate instead of the shift collate.

Further, a control panel failure as the type of fault is associated with rebooting as the quick fix technique. It should be noted that in a case in which the fault is the control panel failure, the output capability information is set to “Output is Impossible”, because a screen cannot be output (displayed) on the control panel because a fault is occurring in the control panel.

It should be noted that although in an example illustrated in FIG. 14, the quick fix technique indicates only a name of the quick fix technique, in fact, the quick fix technique indicates a detailed technique of the quick fix.

In the present embodiment, the instructing unit 259 refers to the quick fix determination information stored in the quick fix determination information storage unit 261 to determine the quick fix technique indicated by the quick fix determination information associated with the fault type information indicating the type identified by the identifying unit 257 as the quick fix technique that enables working around the fault of the type identified by the identifying unit 257 and the continued use of the equipment 10.

Next, the instructing unit 259 refers to the quick fix determination information stored in the quick fix determination information storage unit 261 to determine whether the fault of the type identified by the identifying unit 257 is a fault for which output of the quick fix technique is impossible (S305). More specifically, the instructing unit 259 refers to the quick fix determination information stored in the quick fix determination information storage unit 261, and determines that the output of the quick fix technique is possible when the fault type information indicating a type of fault identified by the identifying unit 257 is associated with the output capability information indicating that output is possible. On the contrary, when the fault type information indicating a type of fault identified by the identifying unit 257 is associated with the output capability information indicating that output is impossible, the instructing unit 259 determines that the output of the quick fix technique is impossible for the corresponding fault.

FIG. 15 is a sequence diagram illustrating steps in an operation of outputting the quick fix technique, performed by the system 1 of the present embodiment in a case in which the identified fault is a fault for which the output of the quick fix technique is possible. This operation is performed in a case in which the instructing unit 259 determines that the output of the quick fix technique is possible for the fault at S305 in the sequence diagram of FIG. 13.

First, the instructing unit 259 sends, to the equipment 10 in which the fault has occurred, an instruction for outputting the determined quick fix technique (S401). The instruction receiver 155 of the equipment 10 receives the instruction. In the present embodiment, a description is given of an example, not limited thereto, in which the instructing unit 259 transmits, to the equipment 10, the quick fix technique information indicating the determined quick fix technique, and the instruction receiver 155 of the equipment 10 receives the quick fix technique information. Thus, the equipment 10 is instructed to output the quick fix technique.

Next, the instructing unit 259 generates the action status information indicating how the fault of the equipment 10 is being handled, and stores the action status information in the action status information storage unit 265 (S403). FIG. 16 is an illustration for describing an example of the action status information stored in the action status information storage unit 265 according to the present embodiment. In an example illustrated in FIG. 16, the action status information for the fault of the equipment 10 includes the equipment identification information of the equipment 10, the fault type information indicating the type of the fault of the equipment 10, and “Waiting for Dispatch of Maintenance Person” as an action status taken to deal with the fault of the equipment 10. However, these are just an example of the action status information, and any other suitable information item may be included.

Next, the output controller 157 of the equipment 10 controls the control panel 920 to output (display) the quick fix technique information received by the instruction receiver 155 (S405). Thus, a customer as a user of the equipment 10 is able to use the equipment 10 as working around the fault that has occurred in the equipment 10.

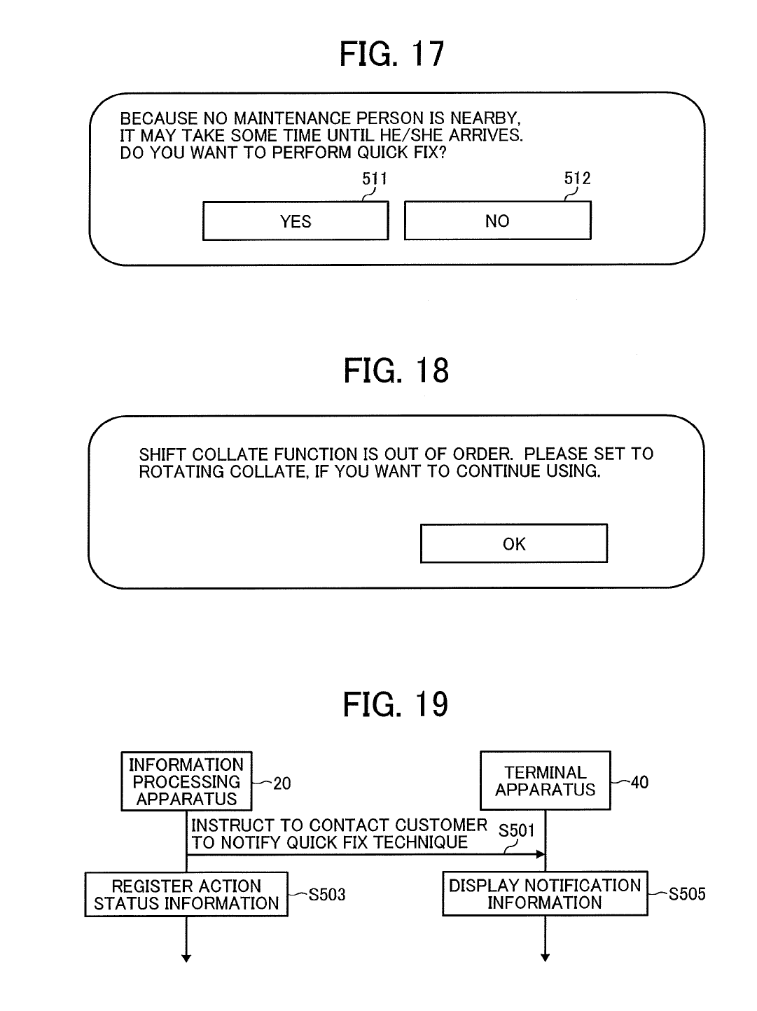

It should be noted that in the present embodiment, in response to receiving the quick fix technique by the instruction receiver 155, the output controller 157 controls the control panel 920 to display a confirmation screen as illustrated in FIG. 17 inquiring whether to perform the quick fix. In response to a selection (touch) of a “YES” key 511 by a user of the equipment 10, the acceptor 159 accepts, from the control panel 920, an instruction to output the quick fix technique. Accordingly, the output controller 157 controls the control panel 920 to display a screen as illustrated in FIG. 18 indicating the quick fix technique. It should be noted that in an example illustrated in FIG. 18, the quick fix technique to be performed to address the shift collate fault is displayed.

By contrast, in response to a selection (touch) of a “NO” key 512 by a user of the equipment 10, the acceptor 159 accepts, from the control panel 920, an instruction not to output the quick fix technique. Accordingly, the output controller 157 does not control the control panel 920 to display a screen indicating the quick fix technique.

Although in the present embodiment, a description is given of an example in which the output controller 157 displays the screen indicating the quick fix technique on the control panel 920 as the output of the quick fix technique, the output is not limited to this display. For example, in a case in which the equipment 10 includes an audio output device such as a speaker, the output controller 157 may control the audio output device to output audio indicating the quick fix technique.

In addition, although in the present embodiment, a description is given of an example in which one quick fix technique is determined, the quick fix technique could be more than one. For example, in a case in which plural faults are occurring in the equipment 10, the quick fix technique may be more than one. In this case, the output controller 157 may control the control panel 920 to display a screen listing multiple quick fix techniques. Alternatively, the output controller 157 may control the control panel 920 to display one screen at time from among a plurality of screens each indicating one quick fix technique.

FIG. 19 is a sequence diagram illustrating steps in an operation of reporting the quick fix technique, performed by the system 1 of the present embodiment in a case in which the identified fault is a fault for which the output of the quick fix technique is impossible. This operation is performed in a case in which the instructing unit 259 determines that the output of the quick fix technique is impossible for the fault at S305 in the sequence diagram of FIG. 13.

First, the instructing unit 259 sends, to the terminal apparatus 40, an instruction for contacting a customer as a user of the equipment 10 in which the fault has occurred to notify the determined quick fix technique (S501). Accordingly, the contact instruction receiver 451 of the terminal apparatus 40 receives this instruction from the instructing unit 259. In the present embodiment, a description is given of an example, not limited thereto, in which the instructing unit 259 transmits, to the terminal apparatus 40, the quick fix technique information indicating the determined quick fix technique, and contact information including the customer identification information and the customer contact information contained in the customer information of the customer stored in the customer information storage unit 263, and the contact instruction receiver 451 of the terminal apparatus 40 receives this contact information. Thus, the terminal apparatus 40 is instructed to notify the customer of the determined quick fix technique.

Next, the instructing unit 259 generates the action status information indicating how the fault of the equipment 10 is being handled, and stores the action status information in the action status information storage unit 265 (S503). It should be noted that an operation of S503 is performed in substantially the similar manner as described above referring to S403 in the sequence diagram of FIG. 15.

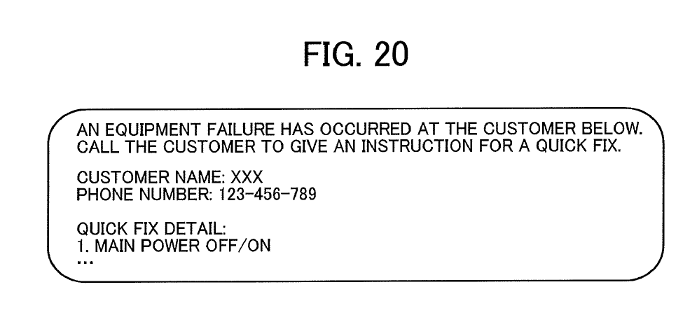

Next, the display controller 453 of the terminal apparatus 40 controls the display device 44 to display the contact information received by the contact instruction receiver 451 (S505). FIG. 20 is an illustration for describing an example of the contact information displayed by the display controller 453 according to the present embodiment. In an example illustrated in FIG. 20, a phone number of the customer of the equipment 10 and a content of the quick fix technique are displayed as the contact information. Accordingly, an operator at a call center who uses the terminal apparatus 40 is able to make a phone call to the customer of the equipment 10 to explain the quick fix technique against the fault that has occurred at the equipment 10. It should be noted that in an example illustrated in FIG. 20, the quick fix technique to be performed to address the control panel fault is displayed.

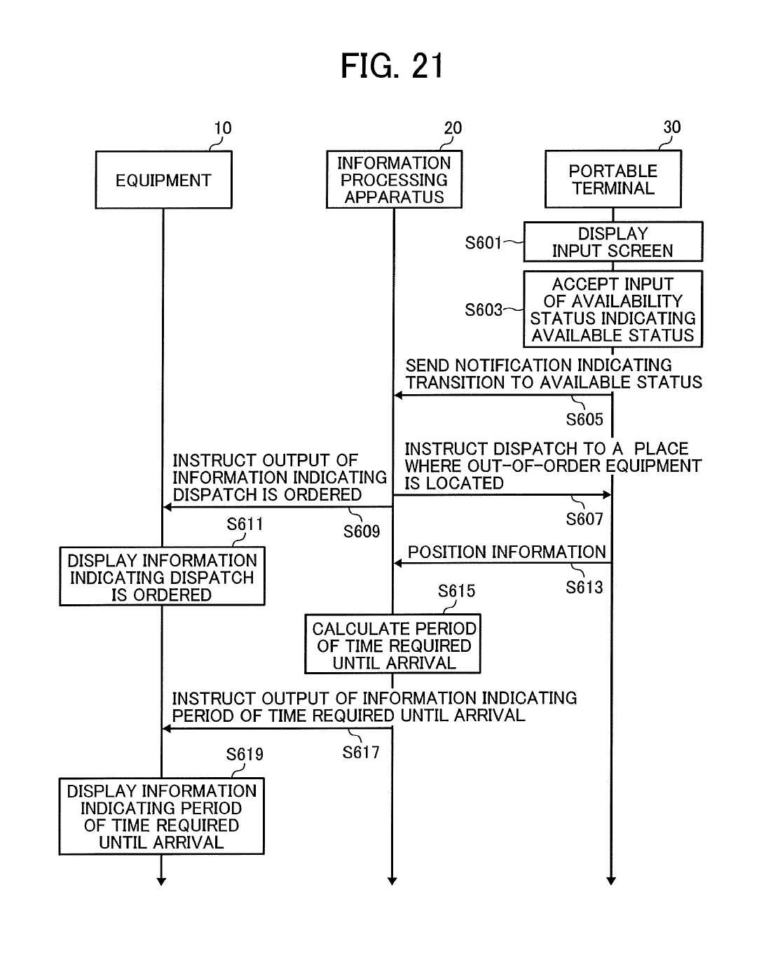

FIG. 21 is a sequence diagram illustrating steps in an operation of dispatching a maintenance person to a customer, performed by the system 1 according to the present embodiment, after the output of the quick fix technique. This operation is performed after the operation illustrated in FIG. 15 or FIG. 19.

First, the acceptor 355 of the portable terminal 30 carried by a maintenance person who transitions from the unavailable state to the available state in which the maintenance person is available for dealing with new maintenance tasks accepts an operation input that instructs to display the input screen as illustrated in FIG. 8. The operation input is entered by the maintenance person through the input device 35. In response to receiving the operation input by the acceptor 355, the display controller 353 controls the display device 34 to display the input screen (S601).

Next, the acceptor 355 accepts an input of the availability status indicating the available status entered by the maintenance person who carries the portable terminal 30 through the input device 35 (S603).

Next, the transmitter 357 of the portable terminal 30 transmits, to the information processing apparatus 20, an available-status transition notification indicating the availability status (available status) accepted by the acceptor 355 (S605). The instructing unit 259 of the information processing apparatus 20 receives the available-status transition notification from the portable terminal 30. In the present embodiment, a description is given of an example in which the available-status transition notification includes the maintenance person identification information of the maintenance person who is carrying the portable terminal 30 and the location information indicating a location of the portable terminal 30. However, the available-status transition notification is not limited thereto.

Next, based on the received available-status transition notification, the instructing unit 259 transmits, to the portable terminal 30 that transmitted the available-status transition notification at S605, an instruction for dispatch of the maintenance person to a place where the equipment 10 for which a quick fix has been performed, which is a customer environment where the equipment 10 is placed (S607). The inquiry receiver 351 of the portable terminal 30 receives this instruction from the instructing unit 259.

More specifically, in response to receiving the available-status transition notification, the instructing unit 259 checks the action status information stored in the action status information storage unit 265 to determine whether there is an action status information associated with “Waiting for Dispatch of Maintenance Person” as the action status. In a case in which there is the action status information associated with “Waiting for Dispatch of Maintenance” as the action status, the instructing unit 259 transmits, to the portable terminal 30 which transmitted the available-status transition notification, the dispatch information including a location of the customer environment where the equipment 10 that is associated with “Waiting for Dispatch of Maintenance Person” as the action status and a type of the fault that has occurred in the equipment 10. In response to receiving the dispatch information, the inquiry receiver 351 of the portable terminal 30 instructs the dispatch of the maintenance person to the user environment.

It should be noted that the location of the user environment where the equipment 10 associated with “Waiting for Dispatch of Maintenance Person” as the action status is identified based on the customer location information associated with the equipment identification information that is the same as the equipment identification information associated with “Waiting for Dispatch of Maintenance Person” as the action status, from among a plurality of pieces of customer location information contained in the customer information stored in the customer information storage unit 263. Further, the type of fault that has occurred in the equipment 10 is identified based on the fault type information associated with the “Waiting for Dispatch of Maintenance Person” as the action status.

Next, the display controller 353 of the portable terminal 30 controls the display device 34 to display the dispatch information received by the inquiry receiver 351.

Subsequently, the instructing unit 259 sends, to the equipment 10 to which the maintenance person is dispatched, an instruction for outputting information indicating the maintenance person has been dispatched (S609). The instruction receiver 155 of the equipment 10 receives this instruction. In addition, the instructing unit 259 updates the action status information for which the dispatch of the maintenance person is instructed so that the action status is changed from “Waiting for Dispatch of Maintenance Person” to “Maintained Person Dispatched”.

Next, in response to receiving, by the instruction receiver 155, an instruction for outputting information indicating that the maintenance person has been dispatched, the output controller 157 of the equipment 10 controls the control panel 920 to output (display) information indicating that maintenance person has been dispatched (S611). Thus, a customer as a user of the equipment 10 is able to recognize that the maintenance person will arrive soon and maintenance of the equipment 10 will be performed.

After the transmission of the available-status transition notification to the information processing apparatus 20, the transmitter 357 of the portable terminal 30 periodically notifies the information processing apparatus 20 of the location information of the portable terminal 30 (S613). The instructing unit 259 of the information processing apparatus 20 receives this location information from the portable terminal 30.

Next, based on the received location information, the instructing unit 259 calculates a dispatch time, which is time taken for the maintenance person who is carrying the portable terminal 30 that sent the notification of the location information to be dispatched to the location of the equipment 10 for which the quick fix has been performed, i.e., the customer environment where the equipment 10 is placed (S615). More specifically, the instructing unit 259 calculates a distance (e.g., a straight line distance) between the location of the maintenance person and the location of the customer environment, based on the location indicated by the received location information and the location of the customer environment identified at S607. Further, the instructing unit 259 divides the calculated distance by a moving speed of the maintenance person to obtain the dispatch time. It should be noted that the moving speed of the maintenance person may be determined in advance.

Next, the instructing unit 259 sends, to the equipment 10 to which the maintenance person is to be dispatched, an instruction for displaying the calculated dispatch time (S617). The instruction receiver 155 of the equipment 10 receives this instruction.

Next, in response to receiving, by the instruction receiver 155, an instruction for outputting the dispatch time, the output controller 157 of the equipment 10 controls the control panel 920 to output (display) the dispatch time (S619). Thus, a customer as a user of the equipment 10 is able to recognize an arrival time of the maintenance person.

As described heretofore, according to the present embodiment, even in a case in which no maintenance person is available for dispatch to fix a fault occurring in the equipment 10, the equipment 10 outputs the quick fix technique that enables working around the fault to enable a customer (user) to continue to use the equipment. Accordingly, the system 1 enables a user to use the equipment 10 in which the fault has occurred without placing a burden on the user.

In particular, according to the present embodiment, even in a case in which no maintenance person is available for dispatch, a user is able to use the equipment in which a fault has occurred without performing maintenance of the fault by user himself/herself. Accordingly, the system according to the present embodiment is useful to users who have no technical knowledge.

Thus, according to the present embodiment, even in a case in which no maintenance person is available for dispatch to fix a fault that has occurred in equipment, a user is able to use the equipment in which the fault has occurred. Accordingly, a situation is avoided in which the user is not able to use the equipment.

[Variation 1]

In the embodiment described above with reference to FIGS. 1 to 21, a description is given of an example in which in response to the acquisition of the status information by the status information acquisition unit 251, the checker 253 queries each of the portable terminals 30-1 to 30-N for an availability status to check whether there is a maintenance person who is in the available state. Alternatively, the checker 253 may receive the availability status information indicating the latest availability status of the maintenance person from each of the portable terminals 30-1 to 30-N in real time. In this case, in response to the acquisition of the status information by the status information acquisition unit 251, the checker 253 may check whether there is a maintenance person who is in an available state by using the received availability status information.

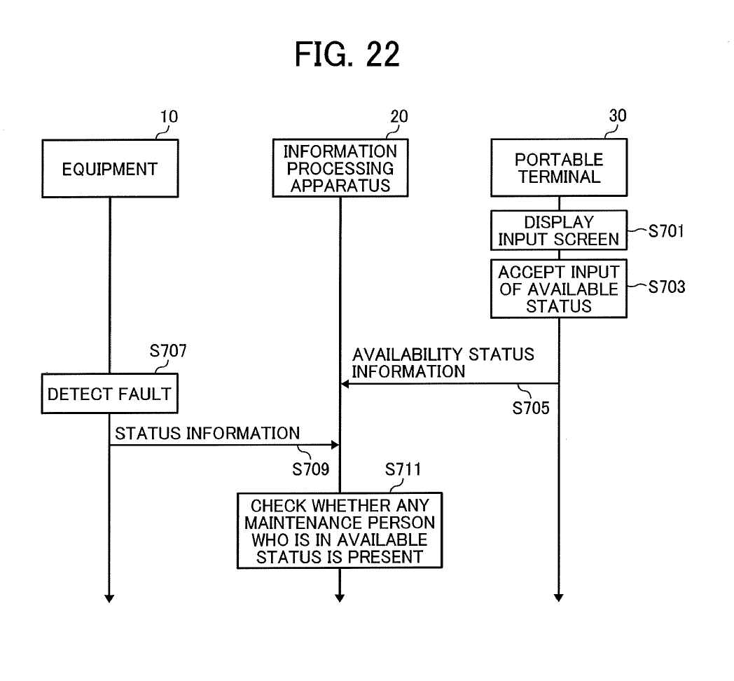

FIG. 22 is a sequence diagram illustrating steps in an operation from a step of detecting a fault to a step of determining presence of a maintenance person who deals with the maintenance of the fault, the operation being performed by the system 1 according to the variation 1.

First, the acceptor 355 of the portable terminal 30 carried by a maintenance person whose availability status has changed accepts an instruction by the maintenance person for displaying the input screen illustrated in FIG. 8 through the input device 35. In response to the acceptance of the instruction by the acceptor 355, the display controller 353 controls the display device 34 to display the input screen (S701).

Next, the acceptor 355 accepts an input of the availability status indicating the available status or the unavailable status entered by the maintenance person who carries the portable terminal 30 through the input device 35 (S703).

Next, the transmitter 357 of the portable terminal 30 transmits, to the information processing apparatus 20, the availability status information indicating the availability status accepted by the acceptor 355 (S705). The checker 253 of the information processing apparatus 20 receives the availability status information from the portable terminal 30 to store the received information in the availability status information storage unit 255.

Next, the fault detector 151 of the equipment 10 detects a fault that has occurred in the equipment 10 (S707).

Next, in response to the detection of fault by the fault detector 151, the status information notification unit 153 of the equipment 10 notifies the information processing apparatus 20 of status information indicating the status of the equipment 10 (S709). Thus, the status information acquisition unit 251 of the information processing apparatus 20 acquires, from the equipment 10 in which the fault has occurred, the status information of the equipment 10.

Next, the checker 253 refers to a plurality pieces (N-numbers) of the availability status information stored in the availability status information storage unit 255 to check whether any maintenance person who is in the available status is present (S711).

[Variation 2]

In the embodiment described above with reference to FIGS. 1 to 21, a description is given of an example in which the information processing apparatus 20 transmits the quick fix technique information indicating the quick fix technique to the equipment 10 to give an instruction of the quick fix technique to the equipment 10 from the information processing apparatus 20. Alternatively, the equipment 10 may store the quick fix technique information. In this case, the information processing apparatus 20 may transmit, to the equipment 10, information for identifying the quick fix technique information such as an ID of the quick fix technique information to give an instruction of the quick fix technique to the equipment 10 from the information processing apparatus 20.

The program executed in the equipment 10, the information processing apparatus 20, the portable terminal 30, and the terminal apparatus 40 according to the above-described embodiment and the variations 1 and 2 (referred to as “each apparatus according to the above-described embodiment and each variation”, hereinafter) may be provided as being stored, as a file of an installable format or of an executable format, in any desired computer-readable recording medium, such as a compact disc read only memory (CD-ROM), a compact disc-recordable (CD-R), a memory card, a digital versatile disc (DVD), a flexible disk (FD), for distribution.

The program executed in each apparatus according to the above-described embodiment and each variation may be provided as being stored on a computer connected to a network such as the Internet and downloaded via the network. The program executed in each apparatus according to the above-described embodiment and each variation may be provided or distributed via a network such as the Internet. The program executed in each apparatus according to the above-described embodiment and each variation may be provided as being preloaded in a ROM and the like.

The program executed in each apparatus according to the above-described embodiment and each variation is configured in modules for implementing each of the functional units (blocks) described above on a computer. As an actual hardware, for example, the CPU reads out the program from the ROM on the RAM to implement each of the functional units (blocks) on a computer.

According to an embodiment of the present disclosure, even in a case in which no maintenance person is available for dispatch to fix a fault of equipment, it is possible to enable a customer to continue to use the equipment at which the fault has occurred without placing a burden on the customer.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), DSP (digital signal processor), FPGA (field programmable gate array) and conventional circuit components arranged to perform the recited functions.

What is claimed is:

1. An information processing apparatus comprising:
circuitry to:
acquire, from equipment in which a fault has occurred, status information indicating a status of the equipment;
check whether a maintenance person who is in an available state is present from among a plurality of maintenance persons;
identify a type of the fault that has occurred in the equipment, based on the acquired status information; and
in a case in which no maintenance person who is in the available state is present from among the plurality of maintenance persons, instruct the equipment to output a quick fix technique, which enables working around the fault of the identified type to enable continued use of the equipment.

2. The information processing apparatus of claim 1, wherein the circuitry is further configured to:
receive, from each of portable terminals, each being carried by the each of the plurality of maintenance persons, availability status information indicating whether the maintenance person is in the available state or in an unavailable state; and
refer to the received availability status information to check the presence of the maintenance person who is in the available state.

3. The information processing apparatus of claim 2, wherein, in response to the acquisition of the status information, the circuitry is further configured to query each of the plurality of portable terminals for the availability status to receive the availability status information from each of the plurality of portable terminals.

4. The information processing apparatus of claim 1, wherein the circuitry is further configured to refer to quick fix determination information that associates fault type information indicating a type of a fault and a quick fix technique to determine the quick fix technique to be output.

5. The information processing apparatus of claim 4, wherein the quick fix determination information includes, in association with the fault type information, output capability information indicating whether the equipment having a fault corresponding to the associated fault type information is capable of outputting the quick fix technique, and
the circuitry is further configured to refer to the quick fix determination information to instruct an information processing apparatus to make a phone call to notify a user of the equipment of the quick fix technique, in a case in which the equipment having the fault of the identified type is not capable of outputting the quick fix technique.

6. The information processing apparatus of claim 1, wherein the circuitry is further configured to, based on an available-status transition notification from a portable terminal carried by a maintenance person who transitions from the unavailable state to the available state, give an instruction to the portable terminal for dispatch of the maintenance person to a place where the equipment is located.

7. The information processing apparatus of claim 6, wherein the circuitry is further configured to instruct the equipment to output information indicating that the maintenance person has been already dispatched.

8. The information processing apparatus of claim 7, wherein the circuitry is further configured to:
calculate a dispatch time required for the dispatched maintenance person to arrive at the place where the equipment is located based on location information notified from the portable terminal; and
instruct the equipment to output the dispatch time.

9. A method of instructing a quick fix, comprising:
acquiring, from equipment in which a fault has occurred, status information indicating a status of the equipment;
checking whether a maintenance person who is in an available state is present from among a plurality of maintenance persons;
identifying a type of the fault that has occurred in the equipment, based on the acquired status information; and
in a case in which no maintenance person who is in the available state is present from among the plurality of maintenance persons, instructing the equipment to output a quick fix technique, which enables working around the fault of the identified type to enable continued use of the equipment.

10. A computer program product comprising a computer useable medium including a computer-readable program, wherein the computer-readable program when executed on a computer causes the computer to perform a method comprising:
acquiring, from equipment in which a fault has occurred, status information indicating a status of the equipment;
checking whether a maintenance person who is in an available state is present from among a plurality of maintenance persons;
identifying a type of the fault that has occurred in the equipment, based on the acquired status information; and
in a case in which no maintenance person who is in the available state is present from among the plurality of maintenance persons, instructing the equipment to output a quick fix technique, which enables working around the fault of the identified type to enable continued use of the equipment.
